(19) United States
(12) Patent Application Publication
(10) Pub. No.: US 2002/0051072 A1
(43) Pub. Date: May 2, 2002

(54) Image taking apparatus

(76) Inventors: Hironori Sumitomo, Moriguchi-Shi (JP); Noriyuki Okisu, Osakasayama-Shi (JP)

Correspondence Address: SIDLEY AUSTIN BROWN & WOOD, 717 NORTH HARWOOD, SUITE 3400, DALLAS, TX, 75201, US

(21) Appl. No.: 09/942,893

(22) Filed: Aug. 30, 2001

(30) Foreign Application Priority Data
Sep. 5, 2000 (JP) 2000-268122

(51) Int. Cl. H04N 5/235

(52) U.S. Cl. 348/362

(57) ABSTRACT

An image taking apparatus includes an image pick-up element which picks up a plurality of images different in photographing condition, an image memory which temporarily stores the plurality of images picked up by the image pick-up element, an image-number-specifying device which specifies the number of images to be used for creating a composed image among the plurality of images stored in the image memory, and an image composer which creates a composite image by composing images of the number of images specified by the image-number-specifying device.

This application claims priority to Japanese Patent Application No. 2000-268122 filed on Sep. 5, 2000, the disclosure of which is incorporated by reference in its entirety.

### BACKGROUND OF THE INVENTION

1. Field of the Invention

The present invention relates to an image taking apparatus such as a digital camera having a multiplex image-processing function.

2. Description of Related Art

Conventionally, as shown in Japanese Unexamined Laid-open Patent Publication No. H11-187307, an image taking apparatus such as a digital camera having a multiplex image-processing function that creates a hyperresolution image, a pan-focus image or the like by composing a plurality of images different in photographing condition is known.

In this image taking apparatus, the number of images to be composed is previously set or automatically set.

However, in cases where the number of images to be composed is previously set or automatically set as mentioned above, it is difficult to create a user's favorite composite image.

Furthermore, in some cases, there have been problems that an image storing portion such as a RAM for temporarily storing a plurality of photographed images overflows before composing them, and/or the operation time for composing the images increases when the number of images to be composed becomes larger.

### SUMMARY OF THE INVENTION

It is an object of the present invention to provide an image taking apparatus capable of creating a user's favorite composite image.

It is another object of the present invention to provide an image taking apparatus capable of preventing capacity of an image storing portion from being overflowed and/or the operation time for composing images from being increased.

According to a first aspect of the present invention, an image taking apparatus includes an image pick-up element which picks up a plurality of images different in photographing condition, an image memory which temporarily stores the plurality of images picked up by the image pick-up element, an image-number-specifying device which specifies the number of images to be used for creating a composite image among the plurality of images stored in the image memory, and an image composer which creates the composite image by composing images of the number of images specified by the image-number-specifying device.

With this image taking apparatus, since the number of images to be used for creating a composite image is specified, a user's favorite composite image can be created.

According to another aspect of the present invention, an image taking apparatus includes an image pick-up element which picks up a plurality of images different in photographing condition, an imager-pick-up-number controller which variably sets the number of images to be picked up by the image pick-up element, and an image composer which creates a composite image by composing a plurality of images picked up by the number of images set by the image-pick-up-number controller.

With this image taking apparatus, since the number of images to be taken by the image pick-up element can be set variably, it becomes possible to prevent capacity of the image memory from being overflowed and/or the operation time for composing images from being increased.

Other objects and the features will be apparent from the following detailed description of the present invention with reference to the attached drawings.

### BRIEF DESCRIPTION OF THE DRAWINGS

The present invention will be more fully described and better understood from the following description, taken with the appended drawings, in which:

FIG. 1 is a perspective view showing a digital camera according to an embodiment of the present invention;

FIG. 2 is a rear view showing the digital camera shown in FIG. 1;

FIG. 3 is a block diagram showing an electric structure of the digital camera shown in FIG. 1;

FIG. 4 is an explanatory view showing screens displayed on an LCD monitor shown in FIG. 2;

FIG. 5 is a first flow chart showing the operation of the digital camera shown in FIG. 1;

FIG. 6 is a second flow chart showing the operation of the digital camera shown in FIG. 1;

FIG. 7 is a third flow chart showing the operation of the digital camera shown in FIG. 1;

FIG. 8 is a perspective view showing a digital camera according to another embodiment of the present invention;

FIG. 9 is a rear view showing the digital camera shown in FIG. 8;

FIG. 10 is a block diagram showing an electric structure of the digital camera shown in FIG. 8;

FIG. 11 is a first flow chart showing the operation of the digital camera shown in FIG. 8;

FIG. 12 is a second flow chart showing the operation of the digital camera shown in FIG. 8; and

FIG. 13 is a third flow chart showing the operation of the digital camera shown in FIG. 8.

### DETAILED DESCRIPTION OF THE PREFERRED EMBODIMENTS

Preferred embodiments according to the present invention will be explained.

### First Embodiment

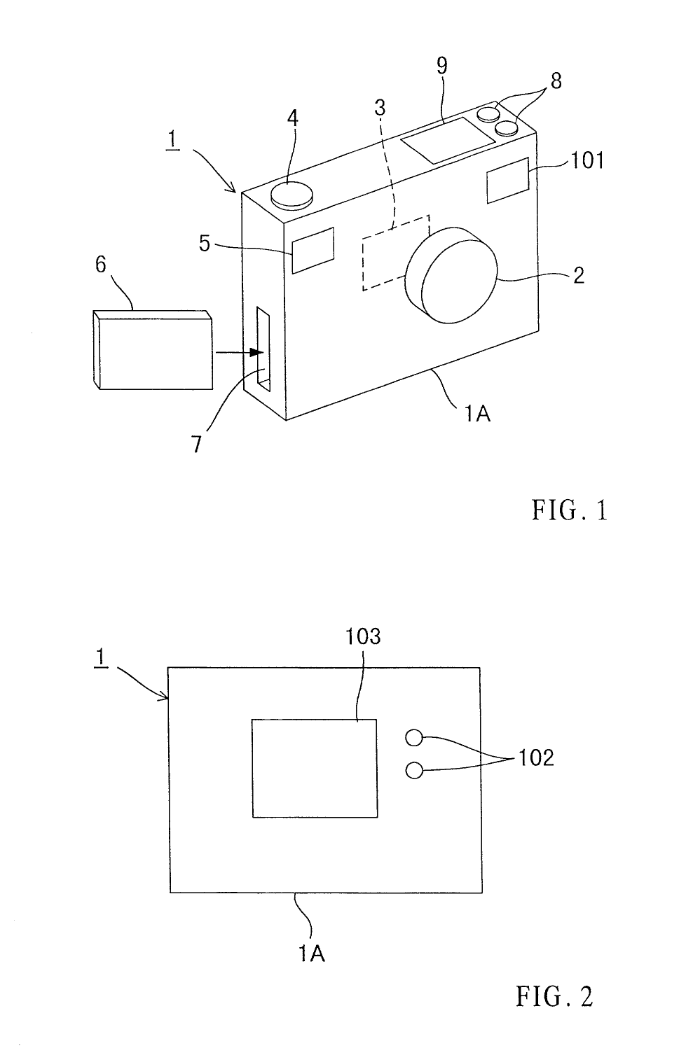

FIG. 1 is a perspective view showing a digital camera as an image taking apparatus according to an embodiment of the present invention, and FIG. 2 is a rear view showing the digital camera.

As shown in FIGS. 1 and 2, on the front face of the camera main body 1A of the digital camera 1, an image taking lens 2 is provided. On the front upper portion thereof, a finder window 5, a distance measurement window 101, etc. are provided. In the camera main body 1A, an image pick-up element 3, which receives an optical image formed by the aforementioned image taking lens 2 and performs a photoelectric conversion of the optical image, is disposed. An image taking unit including the image pick-up element 3 is constituted.

Furthermore, on the upper surface of the camera main body 1A, a shutter start button 4, photographing mode setting keys 8, a liquid crystal display panel 9, etc. are provided. At the side surface of the camera main body 1A, an insertion slit 7 into which a recording media 6 is removably inserted is provided.

The photographing mode setting keys 8 are used for setting an exposure condition, such as an aperture priority exposure and a shutter speed priority exposure, changing macro image taking modes or setting a zoom condition while confirming the contents displayed on the liquid crystal display panel 9.

Furthermore, an LCD monitor 103 for a live-view display, image-processing mode setting keys 102, etc. are provided on the rear face of the camera main body 1A. The image-processing mode setting keys 102 are used for selecting a multiplex image-processing mode or a normal mode, or for selecting one of a quality priority mode, a standard mode, a speed priority mode and an image specify mode while confirming the displayed contents on the LCD panel 103.

This digital camera 1 can record images picked-up by the image pick-up element 3 into the recording media 6 in the same way as conventional digital cameras, and has a multiplex image-processing function which will be executed when the multiplex image-processing mode is set. However, it may be constituted such that the multiplex image-processing function will be executed automatically without setting the multiplex image-processing mode.

In the aforementioned multiplex image-processing mode, processing is carried out for creating a composite image by composing a plurality of images picked up by the image pick-up element 3. The multiplex image-processing includes hyperresolution image creation processing and pan-focus image creation processing, and this embodiment employs the hyperresolution image creation processing. The hyperresolution image creation is a technique for creating a single image with improved resolution from a plurality of slightly shifted images of the same scene. Since the principle thereof is disclosed in Japanese Unexamined Laid-open Patent Publication No. H7-322121, the explanation will be omitted.

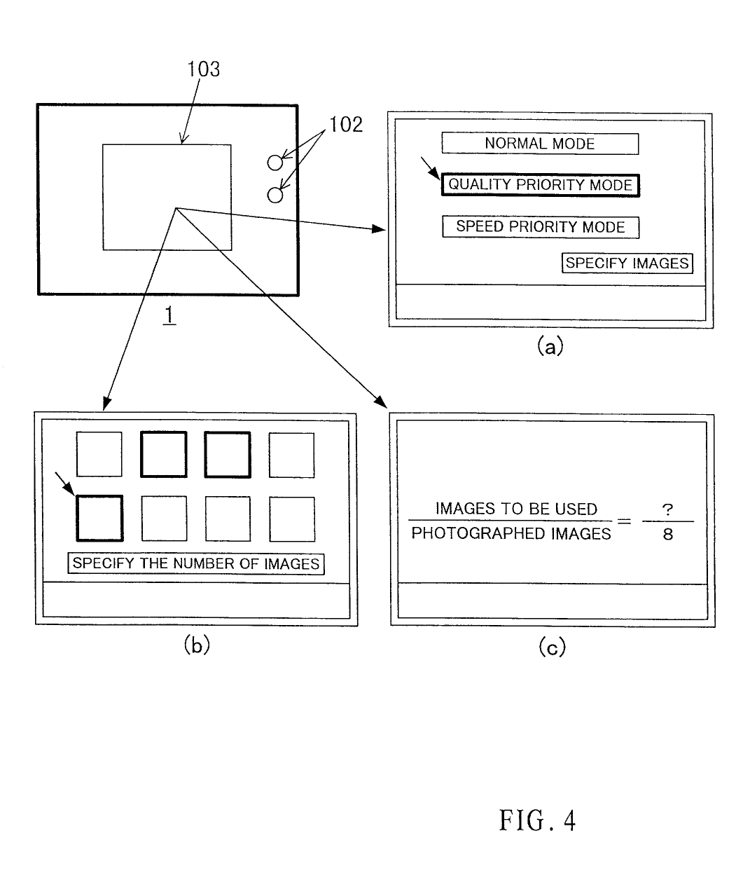

As shown in FIG. 4(a), the aforementioned each mode is displayed on the LCD monitor 103 when the multiplex image-processing mode is set by the image-processing mode setting keys 102, and the user can select one of these modes.

As shown in Table 1, in the quality priority mode, in order to obtain the finest quality of image, images of the maximum photographable number are picked up without considering the processing time, and multiplex image-processing is performed by using all of the images. In the normal mode, in order to improve the quality of image and shorten the processing time, images of the half of the maximum photographable number are picked up, and multiplex image-processing is performed by using these images. In the speed priority mode, in order to minimize the processing time without considering the quality of image, two images are picked up and subjected to multiplex image-processing. Furthermore, in the image specify mode, after picking up images of the maximum photographable number, two or more images to be subjected to multiplex image-processing are specified from all of the images, and multiplex image-processing is performed by using the specified images.

TABLE 1

| | | | | | The number of |
|---|---|---|---|---|---|
| | | | | The number of | images used for |
| | | | | images to be | the multiplex |
| | | | Explanation | taken | image-processing |
| Normal | | | Normal image taking is performed | 1 | |
| Multiplex | Normal | | In order to improve the quality of image and shorten the | Half of the | All of |
| | | | processing time, images of the half of the maximum | maximum | the picked-up |
| | | | photographable number are picked up, and a multiplex | photographable | Images |
| | | | image-processing is performed by using all of the images. | number | |
| | Quality priority | | In order to obtain the finest quality of image, images of | Maximum number | All of |
| | | | the maximum photographable number are picked up without | of | the picked-up |
| | | | considering the processing time, and a multiplex image- | photographable | images |
| | | | processing is performed by using all of the images. | number | |
| | Speed priority | | In order to minimize the processing time without considering | 2 | 2 images |
| | | | the quality of image, two images are picked up and subjected | | |
| | | | to a multiplex image-processing. | | |
| | The above | Images | After picking up images of the maximum photographable | Maximum number | Specified |
| | three | are | number, two or more images to be subjected to a multiplex | of | images |
| | modes are | specified | image-processing are specified by a user from all of the | photographable | |
| | not | | images, and a multiplex image-processing is performed by | number | |
| | specified | | using the specified images. | | |
| | | Numbers | A user specifies the user's favorite number of images among | Maximum number | Specified |
| | | of images | all of the photographed images, and a multiplex image- | of | number |
| | | are | processing is performed by using the specified images. | photographable | |
| | | specified | | number | |

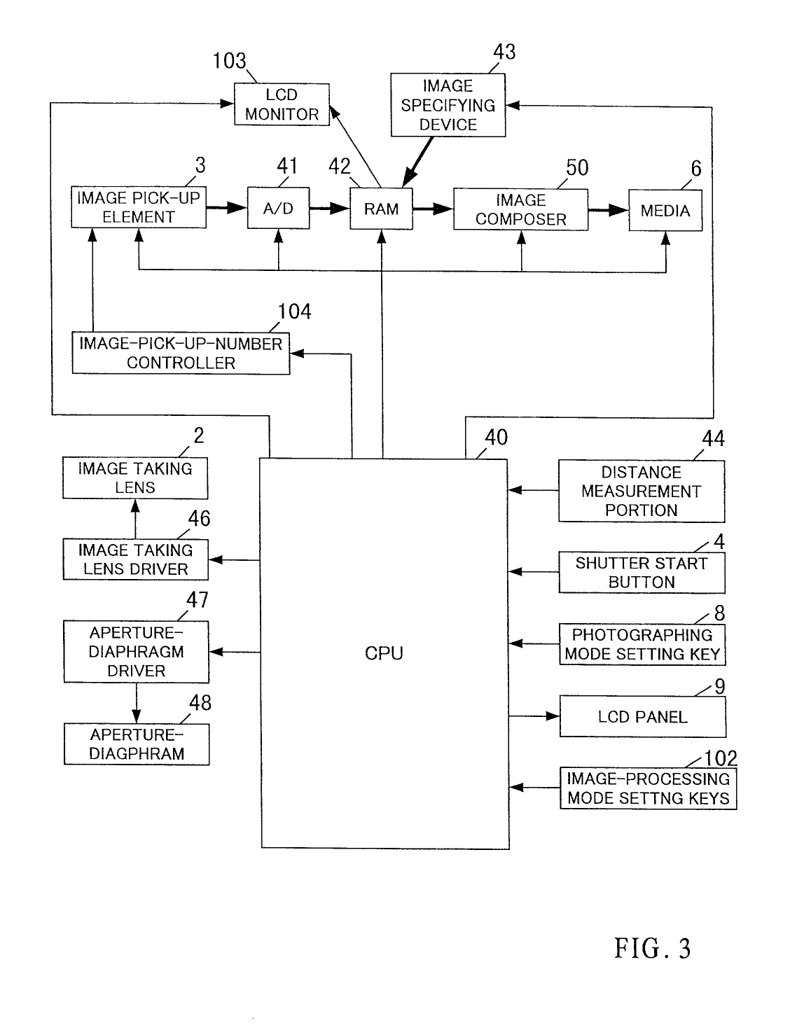

FIG. 3 is a block diagram showing an electric structure of the aforementioned digital camera 1. The thin arrow line and thick arrow line denote the flow of control data and that of image data, respectively. Although each of the below-mentioned members may be an individual circuit and/or mechanical member, each member may be constituted such that a part thereof is shared with each other. Alternatively, at least a part of each member may be attained by software executed by a CPU.

This digital camera 1 includes a CPU 40 for controlling the whole camera, an image-pick-up-number controller 104 for controlling the number of images to be picked-up by the image pick-up element 3, an A/D converter 41 for converting the analog image signal picked up by the image pick-up element 3 into digital image signals, a RAM 42 as an image memory for temporarily storing a plurality of images of the digitalized image signals, an image composer 50 which performs multiplex image-processing for creating a single composite image by composing a plurality of images, an image specifying device 43 for specifying images to be subjected to multiplex image-processing in the image composer 50, etc. Furthermore, the digital camera 1 is provided with an image taking lens driver 46 for driving the image taking lens 2 and an aperture-diaphragm driver 47 for driving an aperture-diaphragm 48 in accordance with the command from the CPU 40.

The aforementioned image-pick-up-number controller 104 controls the image-pick-up-number such that the number of images to be picked up is set to be the maximum photographable number when the quality priority mode is selected, the half of the maximum photographable number when the normal mode is selected, two when the speed priority mode is selected and the maximum photographable number when the image specify mode is selected. The aforementioned photographable maximum number means the number of images that the RAM 42 can store, and is determined by image size and the capacity of the RAM 42.

The aforementioned image specifying device 43 specifies the images to be subjected to the multiplex image-processing in the image composer 50 as mentioned above. In other words, when the image specify mode is selected among the aforementioned modes, the image pick-up element 3 picks up images of the maximum photographable number, and all of the images are stored in the RAM 42. Thereafter, as shown in FIG. 4(b), all of the images stored in the RAM 42 are displayed on the LCD monitor 103 in a thumbnail format. Here, when a user selects two or more images to be subjected to the multiplex image-processing by using the image-processing mode setting keys 102, etc., these selected images are specified by the image specifying device 43. Then, the image composer 50 performs the multiplex image-processing by using the specified images.

Furthermore, when each image of a thumbnail format is displayed on the LCD monitor 103, the language “Specify the number of images” is displayed thereon other than the images. When the number-specify mode is selected without selecting any thumbnail format image displayed on the LCD monitor 103, the number of images stored in the RAM 42 is displayed on the LCD monitor 103 as shown in FIG. 4(c). In this state, when a user inputs the number of images to be subjected to the multiplex image-processing by the image-processing mode setting keys 102, the images of the inputted number among a plurality of images stored in the RAM 42 are automatically specified by the image specifying device 43. The input operation of the number of images may be performed by means other than the image-processing mode setting keys 102.

The image specifying method at this time will be a method for specifying images with lesser noise by measuring the noise amount of all of the images stored in the RAM 42 or a method for specifying images with lesser blur by measuring the blur amount of all of the images stored in the RAM 42. According to these methods, it is possible to specify the images easily even if a user cannot determine which images are to be specified among the images stored in the RAM 42.

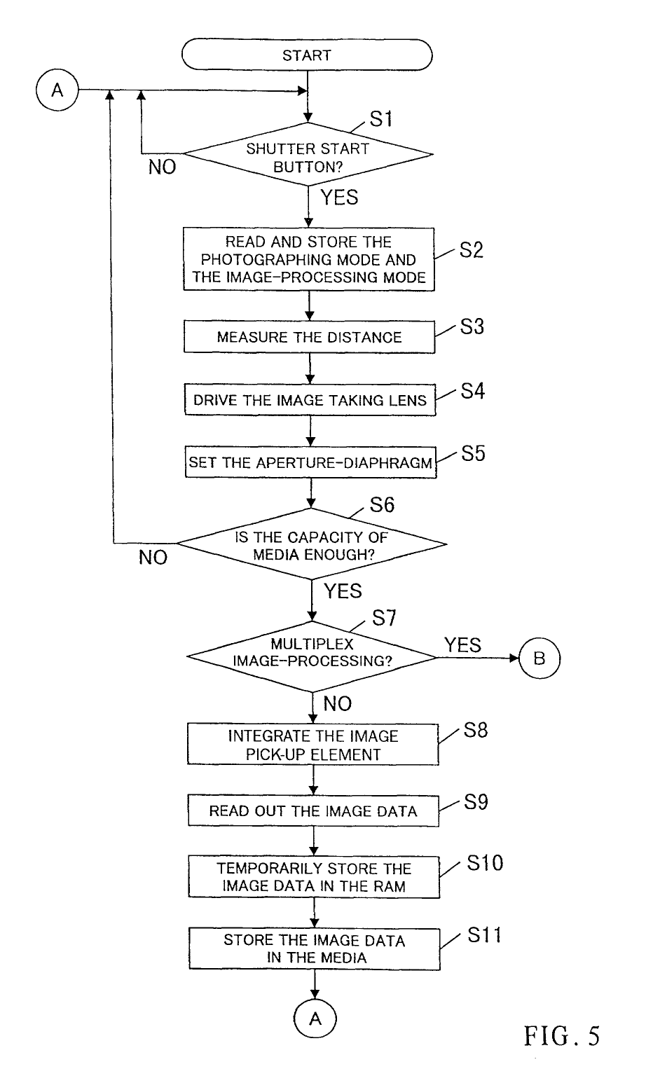

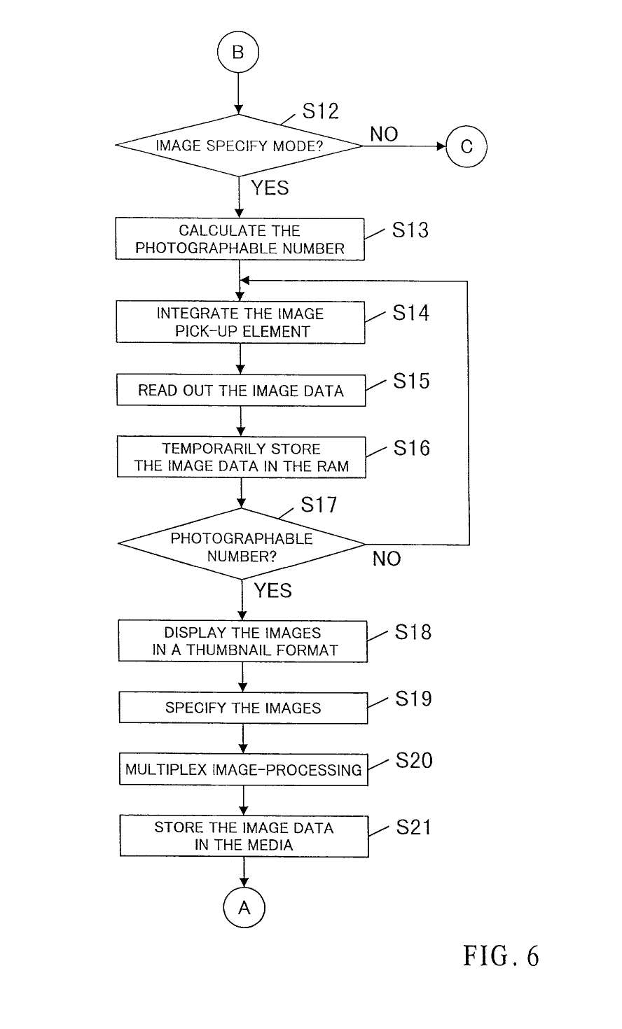

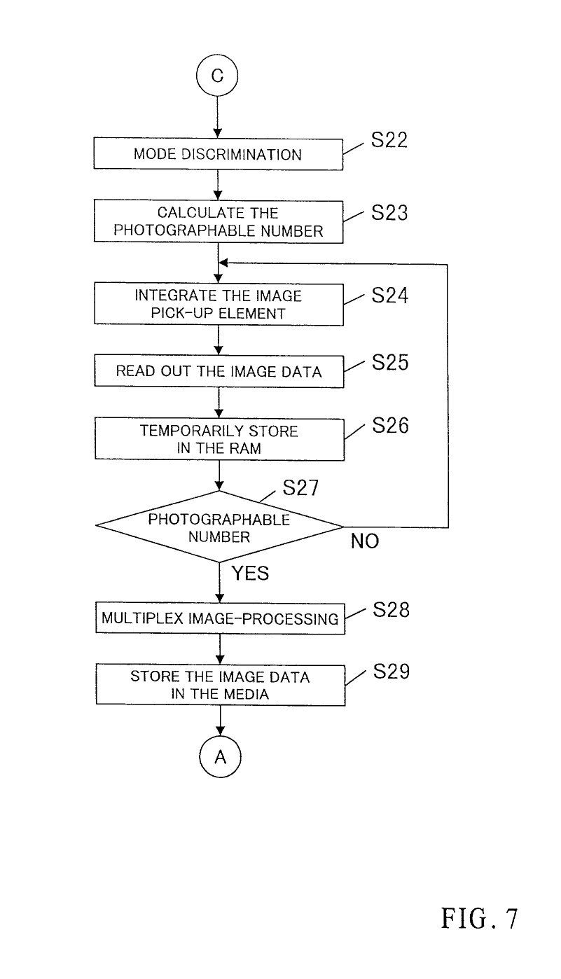

Next, the operation of the aforementioned digital camera 1 will be explained with reference to the flow charts shown in FIGS. 5 and 6. In this explanation, since the basic controls of the digital camera such as a lens drive, an aperture-diaphragm drive, an LCD drive and a flash light emission are well known, these explanation will be omitted. Furthermore, in the following explanation and drawings, “Step” will be abbreviated as “S.”

First, in S1, the CPU 40 judges whether the shutter start button 4 is pressed. When the shutter start button is not pressed (NO in S1), the routine returns. On the other hand, the shutter start button is pressed (YES in S1), the routine proceeds to S2, and the CPU 40 reads and stores the photographing mode and the image-processing mode at that time.

In S3, the distance measurement portion 44 measures the distance to the photographic object, and subsequently in S4, the image taking lens driver 46 drives the image taking lens 2 so as to focus on the photographic object based on the measured distance. Furthermore, in S5, the aperture-diaphragm driver 47 adjusts the aperture-diaphragm 48 appropriately, and the routine proceeds to S6.

In S6, it is discriminated whether the recording media 6 has enough capacity for recording images. When the capacity of the recording media 6 is not enough (NO in S6), the routine returns to S1. On the other hand, when the capacity of the recording media 6 is enough (YES in S6), the routine proceeds to S7, and it is discriminated whether the multiplex image-processing mode is set in the image-processing mode. When the multiplex image-processing mode is not set (NO in S7), the routine proceeds to S8.

In S8, the exposure integration of the image pick-up element 3 is performed, and subsequently in S9, the image data is read out. Then, the routine proceeds to S10. In S10, the read-out image data is converted into digital data in accordance with a pipeline architecture by the A/D converter 41, and the digitalized data is temporarily stored in the RAM 42. Subsequently, in S11, the image data in the RAM 42 is read out and stored in the recording media 6. Then, the routine returns to S1 for the next photographing.

On the other hand, when the multiplex image-processing mode is set in S7 (YES in S7), the routine proceeds to S12 to discriminate whether the image specify mode is set. When the image specify mode is set (YES in S12), the routine proceeds to S13, the photographable number of images is calculated based on the image size and/or the capacity of the RAM 42, and the routine proceeds to S14.

In S14, the exposure integration of the image pick-up element 3 is performed, and subsequently in S15, the image data is read out. Then, in S16, the read-out image data is digitalized by the A/D converter 41 in accordance with a pipeline architecture, and the digitalized image data is temporarily stored in the RAM 42, and the routine proceeds to S17.

In S17, it is discriminated whether the number of picked-up images has reached the photographable number calculated in S13. When the number of images picked up has not reached the photographable number (NO in S17), the routine returns to S14. On the other hand, when the number has reached the photographable number (YES in S17), all of the images stored in the RAM 42 are displayed on the LCD monitor 103 in a thumbnail format to urge a user to select the images to be subjected to the multiplex image-processing or input the number of images. Then, the routine proceeds to S19.

In S19, at the image specifying device 43, the images which a user selected by the image-processing mode setting keys 102, etc. are specified, and the routine proceeds to S20. At this time, when the user inputted the number of images without selecting any image, the image specifying device 43 automatically specifies the images to be subjected to the multiplex image-processing by the number specified by the user.

In S20, the specified image data is read out and subjected to the multiplex image-processing by the image composer 50. Subsequently, in S21, a single composite image to which the multiplex image-processing was executed is recorded in the recording media 6, and the routine returns to S1 for the next photographing.

Furthermore, when the image specify mode is not specified in S12 (NO in S12), the routine proceeds to S22 to discriminate which mode is selected among the quality priority mode, the normal mode and the speed priority mode. In S23, the photographable number depending on each mode is calculated, and the routine proceeds to S24. For example, a photographable maximum number will be calculated as the photographable number when the quality priority mode is selected, the half of the photographable maximum number will be calculated as a photographable number when the normal mode is selected and two will be calculated as the photographable number when the speed mode is selected.

In S24, integration is carried out in the image pick-up element 3, and subsequently in S25, the image data is read out. Thereafter, in S26, the read-out image data is digitalized by the A/D converter 41 in accordance with a pipeline architecture. Then, the digitalized image data is temporarily stored in the RAM 42, and the routine proceeds to S27.

In S27, it is discriminated whether the number of picked-up images has reached the photographable number calculated in S23. When the number has not yet reached the photographable number (NO in S27), the routine returns to S24. On the other hand, when the number has reached the photographable number (YES in S27), the routine returns to S28.

In S28, all of the images stored in the RAM 42 are read out and subjected to the multiplex image-processing by the image composer 50. Furthermore, in S29, a single image to which the multiplex image-processing was executed is recorded in the recording media 6, and the routine returns to S1 for the next photographing.

With this image taking apparatus, since the number of images to be used for creating a composite image is specified, a user's favorite composite image can be created.

In the aforementioned embodiment, although the image taking apparatus has the quality priority mode, the normal mode and the speed priority mode other than the image specify mode, the image taking apparatus may have another modes.

As for the number of images in each of the quality priority mode, the normal mode and the speed priority mode, the number may be set other than the aforementioned number.

Furthermore, the repeat of photographing may be automatically performed by the digital camera, or may be manually performed by a user.

### Second Embodiment

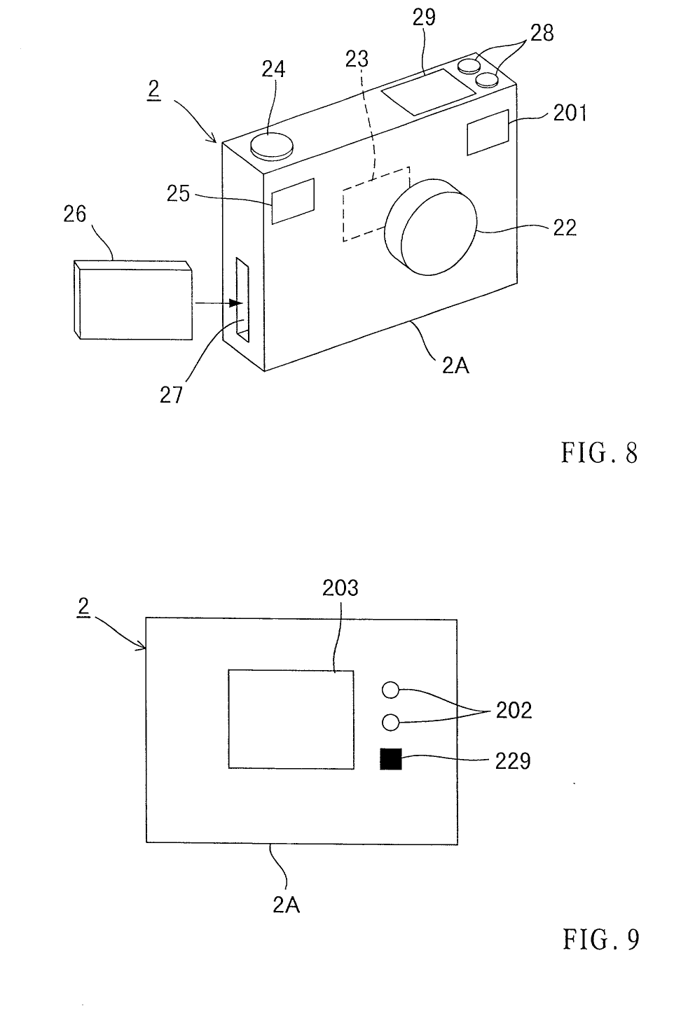

FIG. 8 is a perspective view showing a digital camera as an image taking apparatus according to another embodiment of the present invention, and FIG. 9 is a rear view showing the digital camera.

As shown in FIGS. 8 and 9, on the front face of the camera main body 2A of the digital camera 2, an image taking lens 22 is provided. On the front upper portion thereof, a finder window 25, a distance measurement window 201, etc. are provided. In the camera main body 2A, an image pick-up element 23, which receives an optical image formed by the aforementioned image taking lens 22 and performs a photoelectric conversion of the optical image, is disposed. An image taking unit including the image pick-up element 23 is constituted.

Furthermore, on the upper surface of the camera main body 2A, a shutter start button 24, photographing mode setting keys 28, a liquid crystal display panel 29, etc. are provided. At the side surface of the camera main body 2A, an insertion slit 27 into which a recording media 26 is removably inserted is provided, which have the same function as in the digital camera shown in FIG. 1.

Furthermore, an LCD monitor 203 for a live-view display, image-processing mode setting keys 202 and an image-pick-up-pixel-number setting key 229, etc. are provided on the rear face of the camera main body 2A. The image-processing mode setting keys 202 are used for selecting the aforementioned multiplex image-processing mode, a continuous photographing mode, the normal mode or the like while confirming the displayed contents on the LCD monitor 203. The continuous photographing mode means a mode in which images are continuously taken when the shutter start button 24 is being pressed.

The image-pick-up-pixel-number setting key 229 is used to set the user's favorite number of pixels while confirming the displayed contents on the LCD monitor 203. A CPU, which will be mentioned later, calculates the number of pixels and the photographable number based on the capacity of the RAM 242. An image-pick-up-number controller 204, which will be mentioned later, controls the number of images to be taken by the image pick-up element 23 depending on the photographable number calculated by the CPU 240.

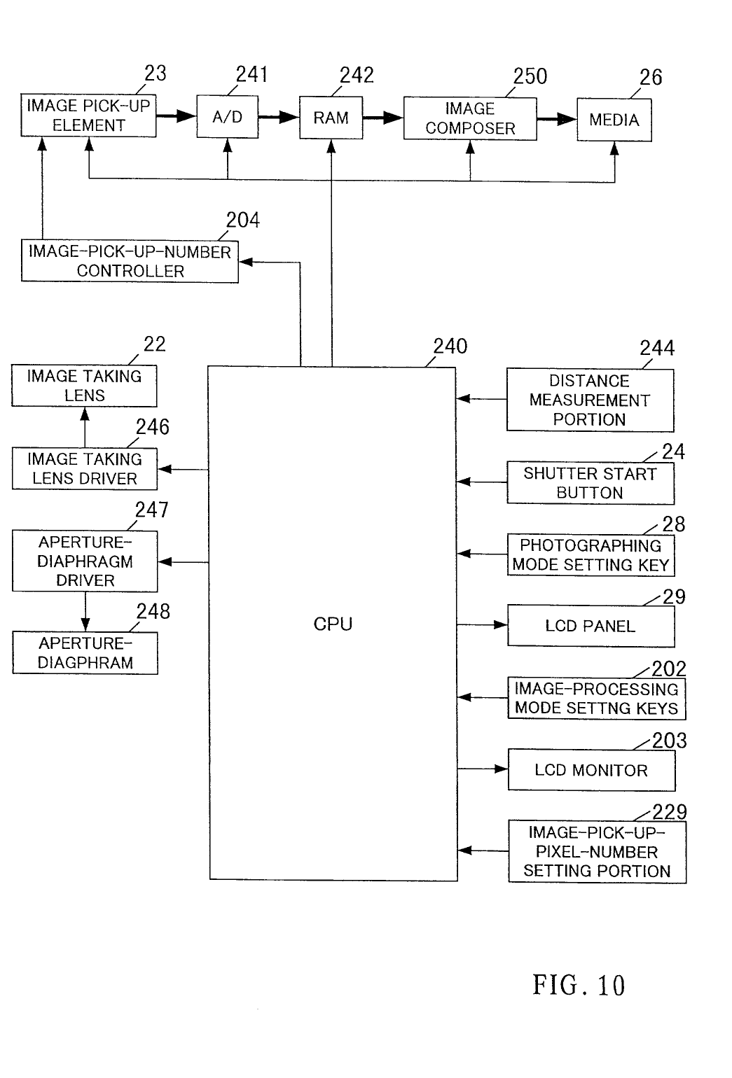

FIG. 10 is a block diagram showing an electric structure of the aforementioned digital camera 2. The thin arrow line and thick arrow line denote the flow of control data and that of image data, respectively. Although each of the below-mentioned members may be an individual circuit and/or mechanical member, each member may be constituted such that a part thereof is shared with each other. Alternatively, at least a part of each member may be attained by software executed by a CPU.

This digital camera 2 includes a CPU 240 for controlling the whole camera, an image-pick-up-number controller 204 for controlling the number of images to be picked up by the image pick-up element 23, an A/D converter 241 for converting the analog image signal picked up by the image pick-up element 23 into digital image signals, a RAM 242 for temporarily storing a plurality of images of the digitalized image signals, an image composer 250 which performs multiplex image-processing for creating a single composite image by composing a plurality of images. Furthermore, the digital camera 2 is provided with an image taking lens driver 246 for driving the image taking lens 22 and an aperture-diaphragm driver 247 for driving an aperture-diaphragm 248 in accordance with the command from the CPU 240.

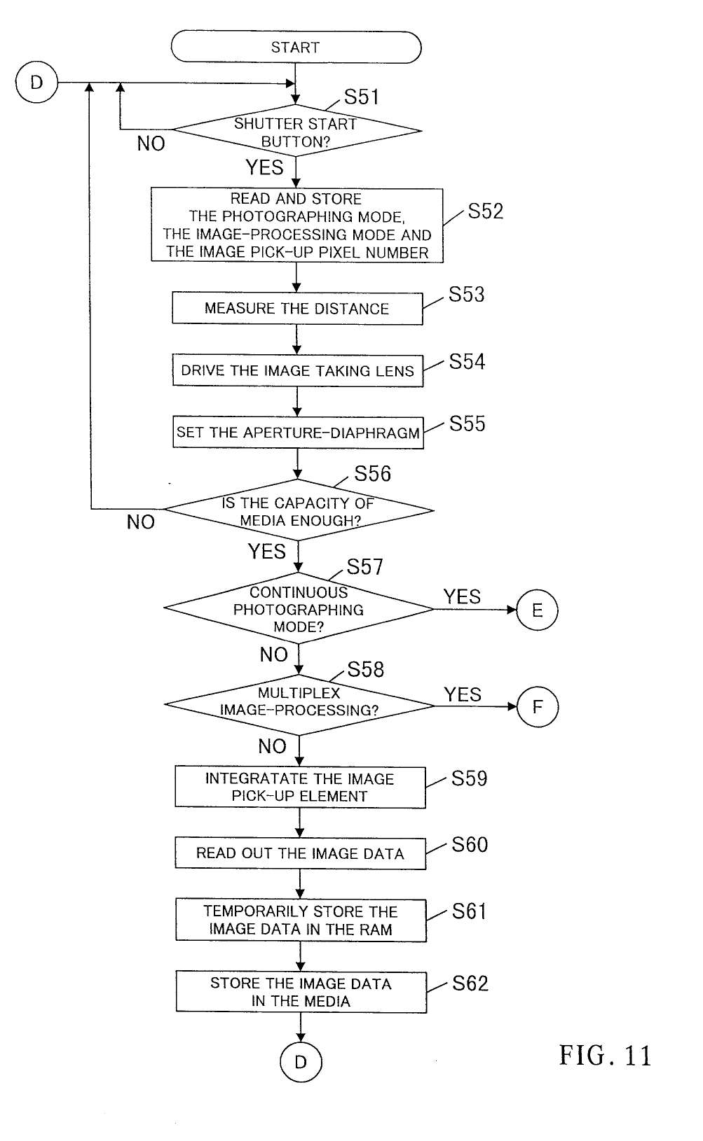

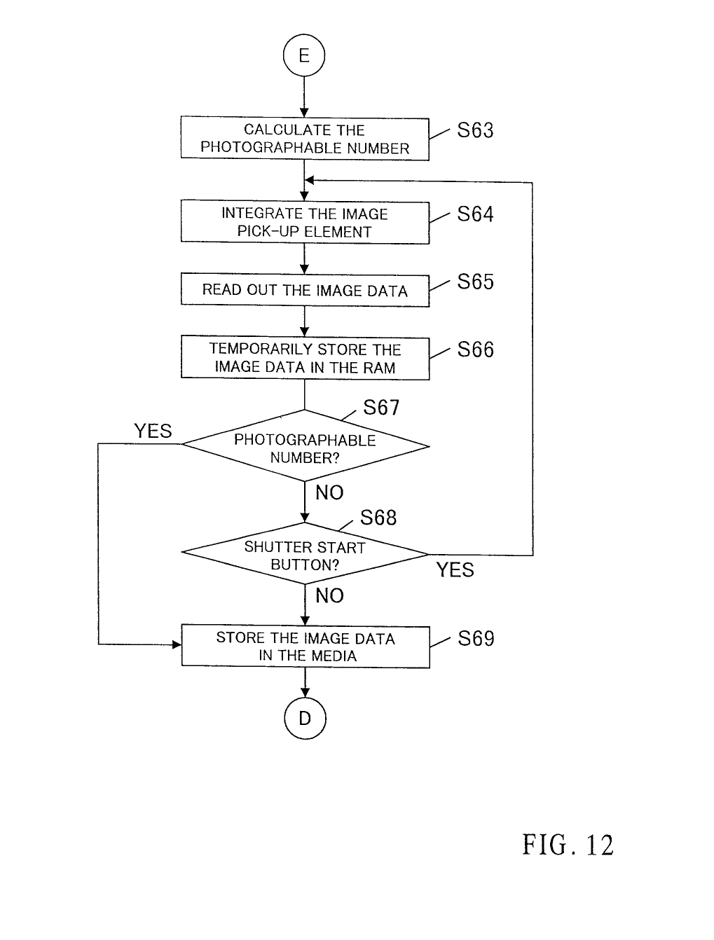

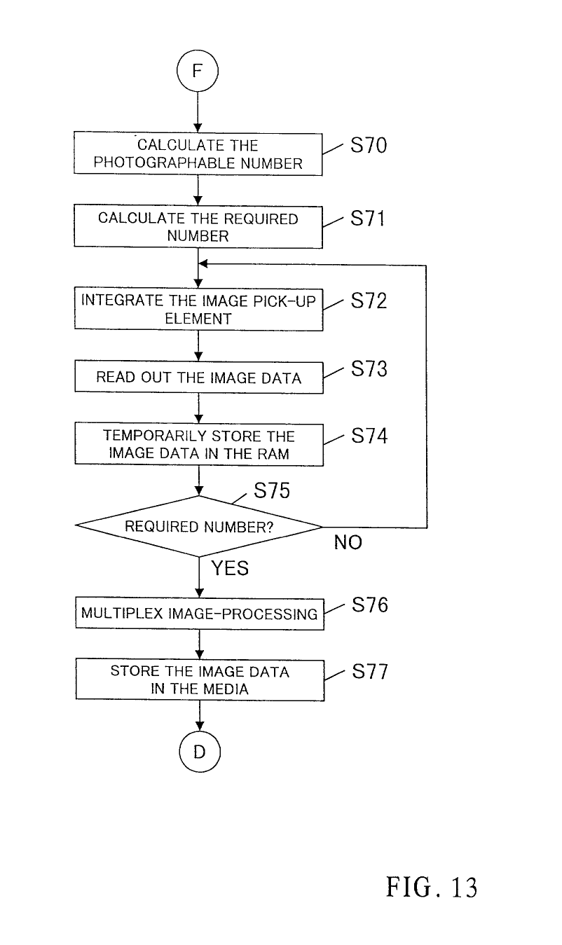

Next, the operation of the aforementioned digital camera 2 will be explained with reference to the flow charts shown in FIGS. 11 to 13. In this explanation, since the basic controls of the digital camera such as a lens drive, an aperture-diaphragm drive, an LCD drive and a flash light emission are well known, these explanation will be omitted. Furthermore, in the following explanation and drawings, “Step” will be abbreviated as “S.”

First, in S51, the CPU 240 judges whether the shutter start button 24 is pressed. When the shutter start button is not pressed (NO in S51), the routine returns. On the other hand, the shutter start button is pressed (YES in S51), the routine proceeds to S52, and the CPU 240 reads and stores the photographing mode, the image-processing mode and the set image-pick-up-pixel-number at that time.

In S53, the distance measurement portion 244 measures the distance to the photographic object, and subsequently in S54, the image taking lens driver 246 drives the image taking lens 22 so as to focus on the photographic object based on the measured distance. Furthermore, in S55, the aperture-diaphragm driver 247 adjusts the aperture-diaphragm 248 appropriately, and the routine proceeds to S56.

In S56, it is discriminated whether the recording media 26 has enough capacity for recording all of the images taken. When the capacity of the recording media 26 is not enough (NO in S56), the routine returns to S51. On the other hand, when the capacity of the recording media 26 is enough (YES in S56), the routine proceeds to S57, and it is discriminated whether the continuous photographing mode is set in the image-processing mode. When the continuous image-processing mode is not set (NO in S57), the routine proceeds to S58. Thus, when the recording media 26 does not have enough capacity for recording all of the photographed images, the CPU 240 controls so as to stop photographing.

In S58, it is discriminated whether the multiplex image-processing mode is set in the image-processing mode. When the multiplex image-processing mode is not set (NO in S58), the routine proceeds to S59, and the exposure integration of the image pick-up element 23 is executed. Thereafter, in S60, the image data is read out, and the routine proceeds to S61.

In S61, the read-out image data is converted into digital data in accordance with a pipeline architecture by the A/D converter 241, and the digitalized data is temporarily stored in the RAM 242. Subsequently, in S62, the image data in the RAM 242 is read out and stored in the recording media 26 by the CPU 240. Then, the routine returns to S51 for the next photographing.

On the other hand, when the continuous photographing mode is set in S57 (YES in S57), in S63, the photographable number is calculated based on the number of pixels set by the image-pick-up-pixel-number setting key 229 and the capacity of the RAM 242, and the routine proceeds to S64.

In S64, the exposure integration of the image pick-up element 23 is performed, and subsequently in S65, the image data is read out. Then, in S66, the read-out image data is digitalized by the A/D converter 241 in accordance with a pipeline architecture, and the digitalized image data is temporarily stored in the RAM 242, and the routine proceeds to S67.

In S67, it is discriminated whether the number of picked-up images has reached the photographable number calculated in S63. When the number of picked-up images has reached the photographable number (YES in S67), the routine returns to S69. On the other hand, when the number has not reached the photographable number (NO in S67), the routine proceeds to S68 and it is discriminated whether the shutter start button 24 is pressed. When the shutter start button 24 is pressed (YES in S68), the routine returns to S64. On the other hand, when the shutter start button 24 is not pressed (NO in S68), the routine proceeds to S69.

In S69, the image data in the RAM 242 is read out and then recorded in the recording media 26. Thereafter, the routine returns to S51 for the next photographing.

On the other hand, when the multiplex image-processing mode is set in S58 (YES in S58), the routine proceeds to S70 to calculate the photographable number based on the number of pixels set by the image-pick-up-pixel-number setting key 229, the capacity of the RAM 242 and the capacity of the recording media 26. Subsequently, in S71, the number of images required for the multiplex image-processing is calculated, and the routine proceeds to S72.

In S72, integration in the image pick-up element 23 is carried out, and subsequently in S73, the image data is read out. Thereafter, in S74, the read-out image data is digitalized by the A/D converter 241 in accordance with the pipeline architecture. Then, the digitalized image data is temporarily stored in the RAM 242.

In S75, it is discriminated whether the number of picked-up images has reached the required number calculated in S71. When the number has not yet reached the required number (NO in S75), the routine returns to S72. On the other hand, when the number has reached the required number (YES in S75), the routine proceeds to S76 and the image data in the RAM 242 is read out and subjected to the multiplex image-processing by the image composer 250. Then, the routine proceeds to S77.

In S77, the composite image to which the multiplex image-processing was performed is stored in the recording media 26, and the routine returns to S51.

With this image taking apparatus, since the number of images to be taken by the image pick-up element is variably set, it is possible to prevent the capacity of the image storing portion from being overflowed and/or the operation time for composing images from being increased.

In this embodiment, the image-pick-up-number controller 204 controls the number of images to be picked up by the image pick-up element 23 depending on the photographable number calculated by the number of pixels and the capacity of the RAM 242. However, the number of images to be picked up by the image pick-up element 23 may be controlled depending on the number of photographed images calculated based on any one of the elements or other element.

Furthermore, the image-pick-up-number controller 204 may control the number of images to be picked up by the image pick-up element depending on the number of images set by a user.

The terms and descriptions in this specification are used only for explanatory purposes and the present invention is not limited to these terms and descriptions. It should be appreciated that there are many modifications and substitutions without departing from the spirit and the scope of the present invention which is defined by the appended claims. A present invention permits any design-change, unless it deviates from the soul, if it is within the limits by which the claim was performed.

What is claimed is:

1. An image taking apparatus, comprising:
an image pick-up element which picks up a plurality of images different in photographing condition;
an image memory which temporarily stores said plurality of images picked up by said image pick-up element;
an image-number-specifying device which specifies the number of images to be used for creating a composite image among said plurality of images stored in said image memory; and
an image composer which creates said composite image by composing images of said number of images specified by said image-number-specifying device.

2. The image taking apparatus as recited in claim 1, wherein the number of images to be stored in said image memory is decided by capacity of said image memory and image size.

3. The image taking apparatus as recited in claim 1, wherein the number of images to be stored in said image memory is the maximum number of images to be stored in said image memory.

4. The image taking apparatus as recited in claim 1, further comprising a display for displaying said plurality of images stored in said image memory side by side.

5. The image taking apparatus as recited in claim 1, further comprising a selector for specifying one of photographing modes and a controller for automatically setting the number of images to be stored in said image memory depending on a specified photographing mode.

6. The image taking apparatus as recited in claim 5, wherein said photographing modes include a mode which gives priority to quality of image and a mode which gives priority to speed.

7. The image taking apparatus as recited in claim 6, wherein the number of images to be stored in said image memory is the maximum number of images that said image memory can store when said mode which give priority to quality of image is specified.

8. An image taking apparatus, comprising:
an image pick-up element which picks up a plurality of images different in photographing condition;
an image-pick-up-number controller which variably sets the number of images to be picked up by said image pick-up element; and
an image composer which creates a composite image by composing a plurality of images picked up by the number of images set by said image-pick-up-number controller.

9. The image taking apparatus as recited in claim 8, further comprising an image memory which temporarily stores a plurality of images picked up by said image pick-up element.

10. The image taking apparatus as recited in claim 9, wherein the number of images to be set by said image-pick-up-number controller is the maximum number that said image memory can store.

11. The image taking apparatus as recited in claim 9, wherein the number of pixels to be picked up is capable of being specified, and wherein the number of images to be set by said image-pick-up-number controller is determined by the number of pixels specified and capacity of said image memory.

12. The image taking apparatus as recited in claim 9, further comprising a controller which discriminates whether it is possible to store images by the number of images set by said image-pick-up-number controller in said image memory, and controls so as not to pick up images when it is discriminated to be impossible to store said images.
